(19) United States
(12) Patent Application Publication
(10) Pub. No.: US 2013/0317632 A1
(43) Pub. Date: Nov. 28, 2013

(54) PLATFORM APPARATUS FOR AGRICULTURAL ENVIRONMENT CONTROL SYSTEM

(71) Applicant: ELECTRONICS AND TELECOMMUNICATIONS RESEARCH INSTITUTE, Daejeon-city (KR)

(72) Inventors: Ae-Kyeung MOON, Daegu (KR); Kyu-Hyung KIM, Daegu (KR); Gwang-Su KIM, Daejeon (KR); Hae-Dong LEE, Daegu (KR); Song LI, Gyeonggi-do (KR); Jang-Sik BAE, Daegu (KR); Sang-Ho LEE, Daegu (KR); Soo-In LEE, Daejeon (KR)

(73) Assignee: Electronics and Telecommunications Research Institute, Daejeon-city (KR)

(21) Appl. No.: 13/838,700

(22) Filed: Mar. 15, 2013

(30) Foreign Application Priority Data
May 25, 2012 (KR) 10-2012-0056122

(51) Int. Cl. G05B 13/02

(52) U.S. Cl. CPC G05B 13/02
USPC 700/79; 700/86

(57) ABSTRACT

A platform apparatus for an agricultural environment control system includes an application support layer unit configured to generate and execute an environment task for supporting an application corresponding to an environment to which the agricultural environment control system is applied, a service layer unit configured to provide service libraries used in the application, a function layer unit configured to perform functions necessary to execute the application, a dynamic adaptation layer unit configured to define the environment task in an application layer irrespective of the number of sensors and actuators installed within the environment to which the agricultural environment control system is applied, and a physical abstraction layer unit configured to generate a mapping table using abstraction results of the sensors and the actuators and enable the agricultural environment control system to access the sensors and the actuators through the mapping table.

### CROSS-REFERENCE TO RELATED APPLICATION

This application claims priority to Korean Patent Application No. 10-2012-0056122, filed on May 25, 2012, which is incorporated herein by reference in its entirety.

### BACKGROUND OF THE INVENTION

1. Field of the Invention

An exemplary embodiment of the present invention relates to a platform apparatus for an agricultural environment control system and, particularly, to a platform apparatus for facilitating the addition and change of at least one sensor and at least one actuator within an agricultural environment control system by providing interfaces and services corresponding to elements for controlling an agricultural environment in the agricultural environment control system and abstracting the sensors and the actuators.

2. Description of Related Art

Severe changes in the environment, such as in atmospheric temperature, the amount of rainfall, and the amount of solar radiation as in recent times, can weaken agricultural productivity, and cases in which outdoor cultivation has been affected by abnormal changes of weather, such as a localized torrential downpour, a super typhoon, and drought, have increased, resulting in a sudden change in food prices. Accordingly, a need for greenhouse environment control technology and plant factories in order to stably supply food is increasing.

A plant factory is a systematic type of agriculture in which plants can be produced according to plan like industrial products by artificially controlling growth environments (e.g. light, air, heat, and nourishment) of living organisms within controlled facilities, and it includes various types of greenhouses, such as a greenhouse using sunshine and a movable sunshine greenhouse.

A conventional greenhouse integration management system uses ubiquitous sensor networking techniques.

For example, Intel Research Berkeley Lab. has constructed a monitoring system for measuring growth environment factors in a wine farm in Oregon, U.S. in order to produce wine of excellent quality. Sensor nodes installed in the wine farm gather environment data, such as temperature, humidity, and luminous intensity and sense activities that occur in the wine farm. The gathered environment data is recorded on a sensor node installed in the shovel of a worker. When the shovel is placed in a shed, the environment data recorded on the shovel is uploaded to a center database. The monitoring system calculates the highest temperature and the lowest temperature, measures the moisture of soil based on the uploaded environment data and supplies water based on the calculated and measured results.

Phytech Ltd. in Israel has developed sensors and software for monitoring information on plant growth and cultivation environment and has applied the sensors and software to farms for cultivating roses, grapes, tomatoes, peppers, and the like. Pieces of information gathered by the sensors are used to improve methods of cultivation, such as an irrigation cycle and the amount of irrigation, and to estimate yield. In the case of greenhouses, the pieces of information enable automatic supply of water and control of temperature. The sensors applied to a tomato farm include an electronic dendrometer, a growth measurement sensor, a stem change sensor, a leaf temperature sensor, an environment sensor, a soil humidity measurement sensor, and the like.

In order to optimize crop growth as described above, a group of sensors for measuring temperature, humidity, and the intensity of radiation are installed. In the case that an abnormality has occurred in an environment according to the results of monitoring using the group of sensors, services. such as control of temperature and control of ventilation through reading or skylight. are possible. Furthermore. if a CO₂ concentration is not appropriate, a service for controlling CO₂ using a CO₂ generator can be provided.

The above tasks are made possible only when a sensor capable of measuring a target environment and a target actuator are provided. Accordingly, the current practice is to construct a system for a single greenhouse, and thus the farming population must pay system construction costs.

### SUMMARY OF THE INVENTION

An embodiment of the present invention is directed to providing a platform apparatus for facilitating the addition and change of at least one sensor and at least one actuator within an agricultural environment control system by providing interfaces and services corresponding to elements for controlling an agricultural environment in the agricultural environment control system and abstracting the sensors and the actuators.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a platform apparatus for an agricultural environment control system includes an application support layer unit configured to generate and execute an environment task for supporting an application corresponding to an environment to which the agricultural environment control system is applied, a service layer unit configured to provide service libraries used in the application, a function layer unit configured to perform functions necessary to execute the application. a dynamic adaptation layer unit configured to define the environment task in an application layer irrespective of the number of sensors and actuators installed within the environment to which the agricultural environment control system is applied, and a physical abstraction layer unit configured to generate a mapping table using the abstraction results of the sensors and the actuators and enable the agricultural environment control system to access the sensors and the actuators through the mapping table.

The application support layer unit may execute the environment task using a control profile.

The control profile may include a configuration profile including information on the sensors and the actuators and a control strategy profile corresponding to a profile to which the agricultural environment control system makes reference when controlling the environment.

The service layer unit may include a basic service unit configured to provide basic services necessary to generate the environment task, a complex service unit configured to provide service libraries necessary to provide services for enabling the agricultural environment control system to control a complex environment, and a management service unit configured to perform services for managing the failure of the sensors and the actuators and services for managing condition information based on sensing information on the sensor.

The basic service unit may include a sensor service library formed of an interface for accessing the sensor, an actuator service library formed of an interface corresponding to the actuator, and a log service library configured to perform services for storing, changing, and deleting gathered data, corresponding to the state of the environment, and previous setting data.

The function layer unit may include a task management unit for managing the environment task, a condition information management unit for managing condition information corresponding to the environment, an event management unit for managing an event occurring in the environment, a failure management unit for managing the failure of the sensors and the actuators installed in the environment, and a communication management unit for managing communication with the application.

### BRIEF DESCRIPTION OF THE DRAWINGS

FIG. 1 shows a schematic configuration of a platform environment to which a platform apparatus for an agricultural environment control system in accordance with an embodiment of the present invention is applied.

FIG. 2 shows the construction of the platform apparatus for an agricultural environment control system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

A platform apparatus 200 for an agricultural environment control system in accordance with an embodiment of the present invention is described in detail below with reference to the accompanying drawings.

The platform apparatus 200 in accordance with the embodiment of the present invention is described by taking an agricultural environment control system applied to a greenhouse environment as an example, but the present invention is not limited to the example.

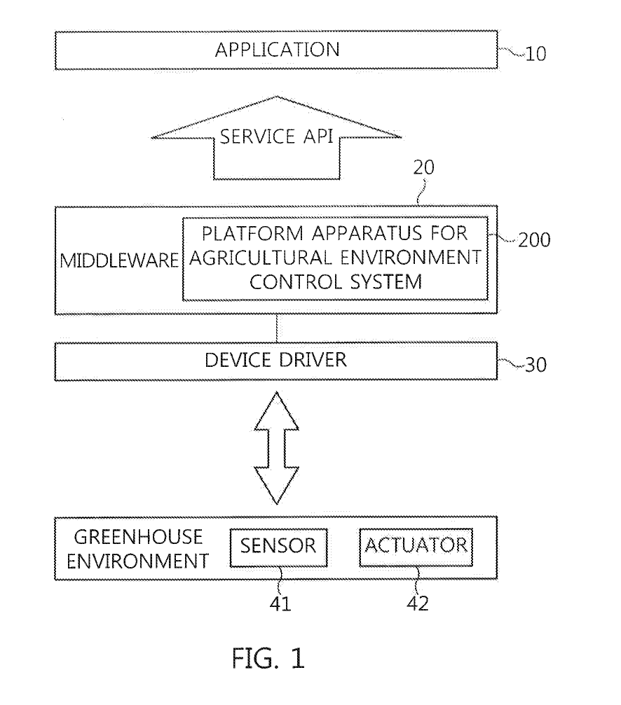

FIG. 1 shows a schematic configuration of a platform environment to which the platform apparatus 200 for an agricultural environment control system in accordance with an embodiment of the present invention is applied.

Referring to FIG. 1, the platform environment in accordance with the embodiment of the present invention includes applications 10, middleware 20, and a device driver 30.

The applications 10 can include applications corresponding to a greenhouse environment, such as a greenhouse control application, a greenhouse monitoring application, and a greenhouse management application.

The platform apparatus 200 for an agricultural environment control system in accordance with an embodiment of the present invention can be applied to the middleware 20, but not limited thereto.

The device driver 30 is responsible for an interface between the platform apparatus 200 and specific devices within the greenhouse environment.

The specific devices within the greenhouse environment correspond to at least one more sensor 41 and at least one actuator 42.

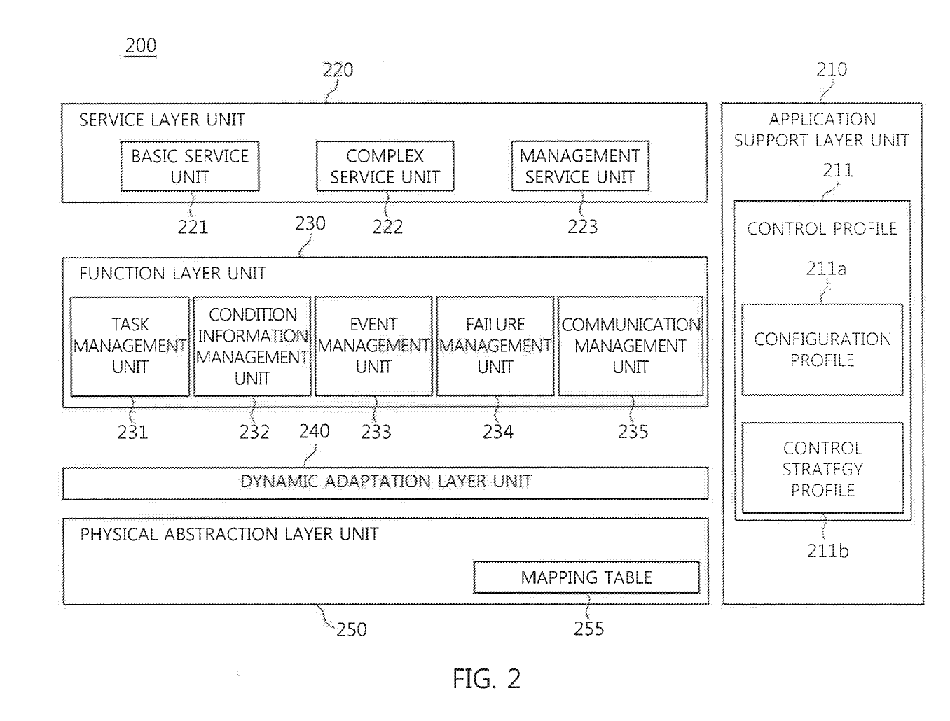

The platform apparatus 200 for an agricultural environment control system is described in detail below with reference to FIG. 2.

FIG. 2 shows the construction of the platform apparatus 200 for an agricultural environment control system in accordance with an embodiment of the present invention.

Referring to FIG. 2, the platform apparatus for an agricultural environment control system 200 includes an application support layer unit 210, a service layer unit 220, a function layer unit 230, a dynamic adaptation layer unit 240. and a physical abstraction layer unit 250. The layer units correspond to an application support layer, a service laver, a function layer, a dynamic adaptation layer, and a physical abstraction layer, respectively.

The application support layer unit 210 generates and executes environment tasks, such as an environment control task and an environment monitoring task for supporting applications corresponding to an agricultural environment, such as a greenhouse environment. Here, the environment task can be executed through a user terminal which operates in conjunction with a greenhouse operating system or a greenhouse operating system that corresponds to an agricultural environment control system, but not limited thereto.

The application support layer unit 210 can develop a task including control logic that corresponds to the experiences of a user who controls the agricultural environment through basic and extension type task templates.

Furthermore, the application support layer unit 210 executes the developed environment task based on specific information, that is, a control profile 211.

The control profile 211 corresponds to information that is necessary for the environment task to be executed in a greenhouse integration controller, for example, and includes a configuration profile 211a and a control strategy profile 211b.

The configuration profile 211a includes information on the sensor 41 and the actuator 42 which are installed in the greenhouse environment.

The control strategy profile 211b corresponds to a profile to which reference is made when controlling an environment in an agricultural environment control system and includes a plurality of control parameters for controlling a variety of environments.

The service layer unit 220 provides service libraries used in the application support layer unit 210. To this end, the service layer unit 220 includes a basic service unit 221, a complex service unit 222, and a management service unit 223.

The basic service unit 221 provides the application support layer unit 210 with basic services that arc necessary to generate an environment task. To this end, the basic service unit 221 includes a sensor service library, an actuator service library, and a log service library.

The sensor service library is chiefly used in a task for monitoring the state of the greenhouse environment and is formed of an interface (e.g., a source code) for accessing the sensor.

The actuator service library is formed of an interface (e.g., a source code) that corresponds to the actuators for controlling the state of the greenhouse environment. Furthermore, in the actuator service library, various types of interfaces can be defined depending on the control mode of an actuator.

The log service library performs services for storing, changing, and deleting gathered data, corresponding to the state of the greenhouse environment, and previous setting data.

The present invention can generate an environment task using the services provided by the basic service unit 221, but the number of sensors and actuators of a greenhouse and what devices are included in what greenhouse need not be defined.

The complex service unit 222 provides pieces of information (e.g., service libraries, such as the calculation of a capacity, the calculation of heating, temperature, and ventilation temperature) necessary to provide services for enabling the agricultural environment control system to control a complex environment. Furthermore, the complex service unit 222 provides interfaces which control a complex environment or which relate to factors affected by the complex environment.

The management service unit 223 provides failure management service and condition information management service. Here, the failure management service is a service for detecting the failure of the sensor 41 and the actuator 42. and providing a user with information on the sensed failure. Furthermore, the condition information management service is a service for storing information sensed by the sensor 41 in a database within the agricultural environment control system and generating statistics and reports based on the sensing information.

The function layer unit 230 performs a function that is necessary for the application 10 to operate normally. To this end, the function layer unit 230 includes a task management unit 231 for managing an environment task, a condition information management unit 232 for managing condition information corresponding to the greenhouse environment, an event management unit 233 for managing an event that occurs in the greenhouse environment, a failure management unit 234 for managing the failure of the at least one sensor 41 and the at least one actuator 42 within the greenhouse environment, and a communication management unit 235 for managing communication with the application 10.

The dynamic adaptation layer unit 240 defines an environment task in an application layer (not shown) irrespective of information on the physical elements (i.e., the number of sensors 41 and actuator 42) of the greenhouse environment. To this end, the dynamic adaptation layer unit 240 provides transparency corresponding to the locations, devices, and control models of the physical elements (e.g., the sensor 41 and the actuator 42) of the greenhouse environment.

Furthermore, the dynamic adaptation layer unit 240 does not need to change an environment task that has been defined in the application layer even if information on the physical elements of the greenhouse environment is changed.

The physical abstraction layer unit 250 generates a mapping table 255 through mapping between the physical elements (e.g., the sensor 41 and the actuator 42) of the greenhouse environment and the device driver 30. Here, the physical elements of the greenhouse environment are abstracted, and the abstraction results and the physical elements are mapped and stored in the mapping table 255.

For example, an application developer can access the sensor 41 within the greenhouse environment using the ID of an abstracted sensor within the mapping table 255.

Furthermore, the designer of the physical abstraction layer unit 250 can access the sensor 41 within the greenhouse environment using the mapping table 255 and provide monitoring service to a higher layer.

As described above, in the platform apparatus in accordance with the exemplary embodiment of the present invention, an sensor and an actuator within an agricultural environment control system can be easily added and changed by providing interfaces and services corresponding to elements for controlling an agricultural environment, such as a greenhouse environment, in the agricultural environment control system and abstracting the sensors and the actuators.

While the present invention has been described with respect to the specific embodiments, it will be apparent to those skilled in the art that various changes and modifications may be made without departing from the spirit and scope of the invention as defined in the following claims.

What is claimed is:

1. A platform apparatus for an agricultural environment control system, comprising:
an application support layer unit configured to generate and execute an environment task for supporting an application corresponding to an environment to which the agricultural environment control system is applied;
a service layer unit configured to provide service libraries used in the application;
a function layer unit configured to perform functions necessary to execute the application;
a dynamic adaptation layer unit configured to define the environment task in an application layer irrespective of a number of sensors and actuators installed within the environment to which the agricultural environment control system is applied; and
a physical abstraction layer unit configured to generate a mapping table using abstraction results of the sensors and the actuators and enable the agricultural environment control system to access the sensors and the actuators through the mapping table.

2. The platform apparatus of claim 1, wherein the application support layer unit executes the environment task using a control profile.

3. The platform apparatus of claim 2, wherein the control profile comprises:
a configuration profile comprising information on the sensors and the actuators; and
a control strategy profile corresponding to a profile to which the agricultural environment control system makes reference when controlling the environment,

4. The platform apparatus of claim 1, wherein the service layer unit comprises:
a basic service unit configured to provide basic services necessary to generate the environment task:
a complex service unit configured to provide service libraries necessary to provide services for enabling the agricultural environment control system to control a complex environment; and
a management service unit configured to perform services for managing a failure of the sensors and the actuators and services for managing condition information based on sensing information on the sensor.

5. The platform apparatus of claim 4, wherein the basic service unit comprises:
a sensor service library formed of an interface for accessing the sensor;
an actuator service library formed of an interface corresponding to the actuator; and
a log service library configured to perform services for storing, changing, and deleting gathered data, corresponding to a state of the environment, and previous setting data.

6. The platform apparatus of claim 1, wherein the function layer unit comprises:
a task management unit for managing the environment task;
a condition information management unit for managing condition information corresponding to the environment;
an event management unit for managing an event occurring in the environment;
a failure management unit for managing a failure of the sensors and the actuators installed in the environment; and
a communication management unit for managing communication with the application.
